(19) United States
(12) Patent Application Publication
(10) Pub. No.: US 2024/0059597 A1
(43) Pub. Date: Feb. 22, 2024

(54) ANAEROBIC AMMONIA OXIDATION TREATMENT SYSTEM FOR TREATING WASTEWATER WITH HIGH AMMONIA NITROGEN AND HIGH COD

(71) Applicant: Beijing Jiaotong University, Beijing (CN)

(72) Inventors: Hong Yao, Beijing (CN); Jingjing Zhang, Beijing (CN); Shaobin Sun, Beijing (CN)

(21) Appl. No.: 18/229,934

(22) Filed: Aug. 3, 2023

(30) Foreign Application Priority Data
Aug. 9, 2022 (CN) 202210951557.8

(51) Int. Cl. C02F 3/30; C02F 3/10; C02F 3/34

(52) U.S. Cl. CPC C02F 3/303; C02F 3/10; C02F 3/308; C02F 3/305; C02F 3/343; C02F 2101/16

(57) ABSTRACT

The system comprises a pre-denitrification unit, an anaerobic ammonia oxidation unit, an advanced denitrification unit and a Fenton unit. The pre-denitrification unit is configured for hydrolyzing suspended pollutants and soluble organic matters in wastewater into organic acids, oxidizing ammonia nitrogen into nitrate, and finally converting the nitrate into nitrogen and absorbing phosphorus. The anaerobic ammonia oxidation unit is configured for converting a part of ammonia nitrogen in the wastewater into nitrite nitrogen through short-cut nitrifying bacteria and reacting the ammonia nitrogen with the nitrite nitrogen through anaerobic ammonia oxidation bacteria to generate nitrogen. The advanced denitrification unit is configured for reducing nitrate nitrogen into nitrogen through a carbon source and removing residual ammonia nitrogen, COD_{Cr} and BOD₅. The Fenton unit is configured for removing refractory organic matters and metal ions and adjusting the pH value of discharged water, so that the discharged water reaches the standard.

### CROSS-REFERENCE TO RELATED APPLICATION

This patent application claims the benefit and priority of Chinese Patent Application No. 202210951557.8 filed with the China National Intellectual Property Administration on Aug. 9, 2022, the disclosure of which is incorporated by reference herein in its entirety as part of the present application.

### TECHNICAL FIELD

The present disclosure relates to the technical field of wastewater treatment, in particular to an anaerobic ammonia oxidation treatment system for treating wastewater with high ammonia nitrogen and high COD (Chemical Oxygen Demand).

### BACKGROUND

The digestive juice of kitchen wastewater is a typical wastewater with high ammonia nitrogen because of high contents of organic matters (above 5000 mg/L) and ammonia nitrogen (above 1000 mg/L). At present, the denitrification technologies of sludge digestive juice mainly include a nitrification-denitrification process and a short-cut nitrification process. The traditional nitrification-denitrification process needs to provide a large amount of organic carbon sources and alkalinity. In addition, the bottleneck problems such as low nitrogen removal load, a large amount of residual sludge and high operating cost also restrict the expansion and application of this process. The anaerobic ammonia oxidation process completely breaks through the basic concept of traditional biological nitrogen removal, and an effective way is found for biological treatment of wastewater with high ammonia nitrogen. According to the process, ammonia nitrogen in sewage can be directly converted into nitrogen by using the biological characteristics of anaerobic ammonia oxidation bacteria, so that 60% of aeration energy consumption can be saved, and 100% of additional carbon sources can be saved. By consuming CO₂, the discharge of greenhouse gases such as CO₂ is reduced without producing residual sludge. However, the anaerobic ammonia oxidation bacteria mainly use inorganic carbon sources for life activities, so when the wastewater with high chemical oxygen demand (COD) concentration, the anaerobic ammonia oxidation bacteria are easily influenced by organic carbon sources to reduce the biological activity, and the application of the anaerobic ammonia oxidation system is limited.

Therefore, it is very necessary to provide a corresponding water treatment system for wastewater with high ammonia nitrogen and high COD.

### SUMMARY

In order to solve the above-mentioned technical problems, the present disclosure provides an anaerobic ammonia oxidation treatment system for treating wastewater with high ammonia nitrogen and high COD.

To achieve the purpose, the present disclosure adopts the following technical scheme.

The present disclosure provides an anaerobic ammonia oxidation treatment system for treating wastewater with high ammonia nitrogen and high COD. The system includes a pre-denitrification unit, an anaerobic ammonia oxidation unit, an advanced denitrification unit and a Fenton unit which are connected in sequence. The pre-denitrification unit is configured for hydrolyzing suspended pollutants and soluble organic matters in wastewater into organic acids, oxidizing ammonia nitrogen into nitrate, and finally converting the nitrate into nitrogen to be discharged and absorbing phosphorus, so that the purposes of short-cut denitrification and phosphorus removal are achieved. The anaerobic ammonia oxidation unit is configured for converting a part of ammonia nitrogen in the wastewater into nitrite nitrogen through short-cut nitrifying bacteria and reacting the ammonia nitrogen with the nitrite nitrogen through anaerobic ammonia oxidation bacteria to generate nitrogen to be discharged, so that nitrogen source pollutants are removed. The advanced denitrification unit is configured for reducing nitrate nitrogen generated in the anaerobic ammonia oxidation unit through a carbon source into nitrogen to be discharged and removing residual ammonia nitrogen, COD_{Cr} and BOD (Biochemical Oxygen Demand) to realize an advanced denitrification. The Fenton unit is configured for removing refractory organic matters and metal ions and adjusting the pH value of discharged water, so that the discharged water reaches the standard.

In some embodiments, the pre-denitrification unit includes a first anoxic tank and a first aerobic tank which are connected to each other. A stirrer is arranged in the first anoxic tank. An aeration unit is arranged at the bottom of the first aerobic tank. The aeration unit includes an aeration disc connected with a blower. The first anoxic tank is configured for hydrolyzing suspended pollutants and soluble organic matters in the wastewater into organic acids through heterotrophic bacteria to short-cutly denitrify the wastewater, converting nitrate brought in by internal backflow into nitrogen to be discharged through denitrifying bacteria. The first aerobic tank is configured for nitrifying the wastewater treated by the first anoxic tank through autotrophic bacteria, so that ammonia nitrogen is oxidized into nitrate; and then the wastewater is refluxed to the first anoxic tank, phosphorus is absorbed through phosphorus accumulating bacteria and residual sludge is discharged to dephosphorize the wastewater.

In some embodiments, a first sedimentation tank is also arranged between the pre-denitrification unit and the anaerobic ammonia oxidation unit. The first sedimentation tank is configured for refluxing the sludge sedimented at the bottom to the first anoxic tank, collecting other residual sludge to a sludge treatment system, and discharging a supernatant to the anaerobic ammonia oxidation unit.

In some embodiments, the anaerobic ammonia oxidation unit includes a reaction compartment and a second sedimentation tank which are connected to each other. The reaction compartment is divided by a baffle into a left compartment and a right compartment which are horizontally arranged. An opening is formed in the baffle. The opening is configured for communicating the left compartment with the right compartment. The left compartment and the right compartment are filled with sponge fillers, and aeration units are arranged at the bottoms of the left compartment and the right compartment. The second sedimentation tank is configured for refluxing the sludge sedimented at the bottom to the reaction compartment, collecting residual sludge to a sludge treatment system, and discharging a supernatant to a first adjustment tank. The first adjustment tank is configured for homogenizing the supernatant and discharging the homogenized supernatant to the advanced denitrification unit.

In some embodiments, the number of the openings is two, and the openings are formed in an upper part and a lower part of the baffle, respectively.

In some embodiments, the advanced denitrification unit includes a second aerobic tank, a second anoxic tank, a third aerobic tank and a third sedimentation tank which are connected in sequence. A stirrer is arranged in the second anoxic tank. Aeration units are arranged at the bottoms of the second aerobic tank and the third aerobic tank. The third sedimentation tank is configured for refluxing the sludge sedimented at the bottom to the second aerobic tank, refluxing part of the treated sludge to the pre-denitrification unit, discharging the residual sludge into a sludge treatment system, and overflowing a supernatant to the Fenton unit.

In some embodiments, the Fenton unit includes a Fenton reaction tank, a Fenton post-reaction tank and a Fenton sedimentation tank which are connected in sequence, and aeration units are arranged at the bottoms of the Fenton reaction tank and the Fenton post-reaction tank. The Fenton reaction tank is configured for the refractory organic matters that are not removed in the anaerobic ammonia oxidation unit and water mixed with generated bubble and discharging the discharged water to the post-Fenton reaction tank. The post-Fenton reaction tank is configured for removing metal ions and adjusting the pH value of the discharged water after the water is homogenized, and discharging the discharged water to the Fenton sedimentation tank. The Fenton sedimentation tank is configured for treating the sludge sedimented by the Fenton unit together with the residual sludge generated by other units in a sludge treatment system and discharging the discharged water that reaches the standard.

In some embodiments, the system also includes a pretreatment unit arranged in front of the pre-denitrification unit, and the pretreatment unit is configured for removing suspended solids and animal and vegetable oils in the wastewater and preliminarily decomposing organic matters such as ammonia and nitrogen in the wastewater to realize COD removal.

In some embodiments, the pretreatment unit includes a water collecting tank and a second adjustment tank. A sewage lift pump is arranged between the water collecting tank and the second adjustment tank. The sewage lift pump is configured for pumping the wastewater collected by the water collecting tank to the second adjustment tank. An aeration unit is arranged at the bottom of the second adjustment tank, and a mud scraper and a waste residue collecting tank are arranged on the top of the second adjustment tank. The mud scraper is configured for moving along a liquid surface to collect the suspended solids and oils and discharging the collected suspended solids and oils to the waste residue collecting tank.

The present disclosure provides application of the anaerobic ammonia oxidation treatment system for treating wastewater with high ammonia nitrogen and high COD according to the above mentioned in treating kitchen wastewater.

Compared with the prior art, the present disclosure provided by the present disclosure at least has the following advantages.

According to the anaerobic ammonia oxidation treatment system for treating wastewater with high ammonia nitrogen and high COD provided by the present disclosure, for the wastewater with high ammonia nitrogen and high COD treated by the system, the removal rates of COD_{Cr}, BOD₅, NH₃—N(Ammonia-Nitrogen), TN (Total Nitrogen), TP (Total Phosphorus), SS (Suspended Solid) and animal and vegetable oils reach above 95%, above 90%, above 98%, above 98%, 95%, above 90% and above 50%, respectively. Moreover, the sewage treatment capacity of the treatment system can reach 200 m³/d. Compared with the traditional A/O (Anoxic/Oxic) biochemical treatment process, the treatment system can save energy by 960 kwh/d, save carbon sources by 2017 kg/d and reduce the amount of sludge by 1.89 t/d, and a total annual cost is saved by about 3.03 million yuan. Finally, the treatment system can also achieve high biological enrichment (10000 mg/L to 15000 mg/L) and maintain high activity.

### BRIEF DESCRIPTION OF THE DRAWINGS

One or more embodiments are illustrated by FIGURES in the corresponding attached FIGURES, and these illustrative descriptions do not constitute limitations on the embodiments, unless otherwise specified, the FIGURES in the attached FIGURES do not constitute scale limitations.

FIG. 1 is a structural schematic diagram of an anaerobic ammonia oxidation treatment system for treating wastewater with high ammonia nitrogen and high COD provided by the present disclosure. Reference signs: 1, water collecting tank; 2, sewage lift pump; 3, second adjustment tank; 4, blower; 5, aeration disc; 6, mud scraper; 7, waste residue collecting tank; 8, residual sewage pipeline; 9, second adjustment tank sewage lift pump; 10, water inlet pipeline of pre-denitrification unit; 11, stirrer; 12, first aerobic tank; 13, water outlet pipeline of pre-denitrification unit; 14, first sedimentation tank; 15, pre-denitrification unit; 16, first anoxic tank; 17, sludge reflux pipeline of pre-denitrification unit; 18, sludge reflux pump of pre-denitrification unit; 19, water outlet pipeline of pre-denitrification unit; 20, anaerobic ammonia oxidation unit; 21, reaction compartment; 22, baffle; 23, sponge filler; 24, second sedimentation tank; 25, residual sludge pipeline of pre-denitrification unit; 26, sludge reflux pipeline of anaerobic ammonia oxidation unit; 27, water outlet pipeline of anaerobic ammonia oxidation unit; 28, first adjustment tank; 29, water outlet pipeline of first adjustment tank; 30, second aerobic tank; 31, advanced denitrification unit; 32, second anoxic tank; 33, third aerobic tank; 34, water outlet pipeline; 35, third sedimentation tank; 36, sludge reflux pump of advanced denitrification unit; 37, sludge reflux pipeline of advanced denitrification unit; 38, biological system sludge reflux pipeline; 39, water outlet pipeline of advanced denitrification unit; 40, Fenton unit; 41, Fenton reaction tank; 42, Fenton post-reaction tank; 43, Fenton sedimentation tank; 44, Fenton unit sedimentation sludge; 45, water outlet pipe of Fenton unit; 46, biological system sludge reflux pump; 47, residual sludge pipeline of advanced denitrification unit; 48, residual sludge pipeline of anaerobic ammonia oxidation unit; and 49, sludge reflux pump of anaerobic ammonia oxidation unit.

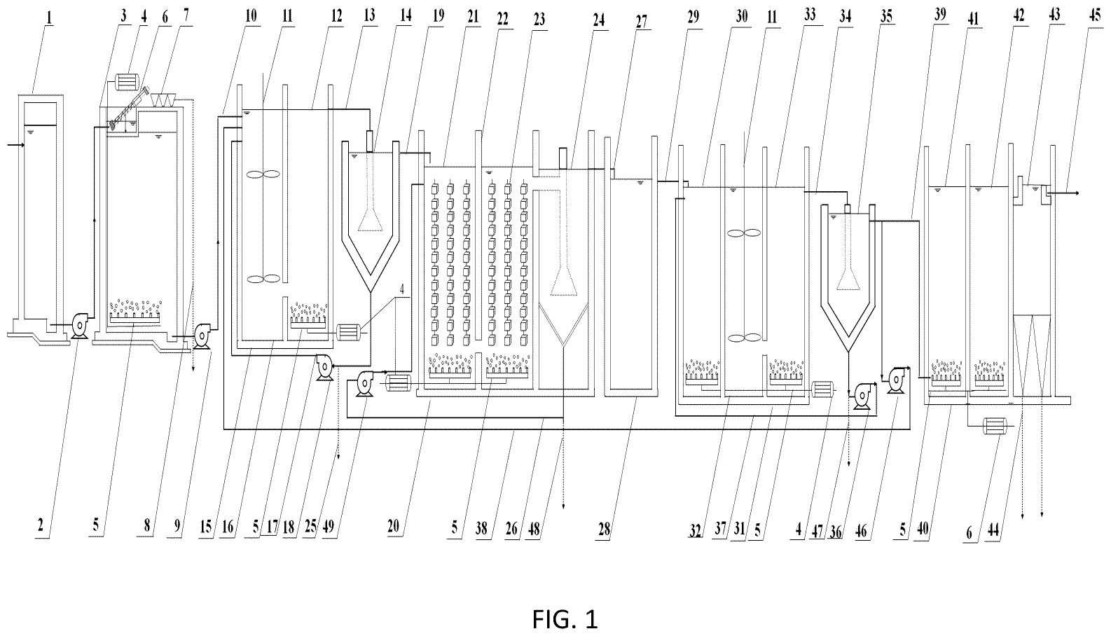

### DETAILED DESCRIPTION OF THE EMBODIMENTS

According to the background technology, the application of the anaerobic ammonia oxidation system is limited because anaerobic ammonia oxidation bacteria are easily affected by organic carbon sources to reduce the biological activity.

On this basis, the present disclosure provides an anaerobic ammonia oxidation treatment system for treating wastewater with high ammonia nitrogen and high COD. In this system, suspended solids (SS) and animal and vegetable oils are firstly removed from wastewater with high ammonia nitrogen and high COD through a pretreatment unit, so that blockage of subsequent treatment pipelines and toxicity to microorganisms are prevented. Moreover, an adjustment tank also acts as an anaerobic tank to preliminarily decompose ammonia, nitrogen and other organic matters in the wastewater, so that the removal rate of COD is improved, and generated oil residue can also be recovered after treatment.

After pretreatment, the wastewater enters a pre-denitrification unit (a first anoxic tank, a first aerobic tank and a first sedimentation tank), the content of COD in incoming water is reduced while the construction and unnecessary operation costs are reduced, the inhibition or toxic effect on the activity of subsequent anaerobic ammonia oxidation bacteria is reduced, and stable operation of an anaerobic ammonia oxidation unit is ensured.

The discharged water from the pre-denitrogenation unit enters the anaerobic ammonia oxidation unit, and NH₄⁺—N ions in the wastewater are removed by anaerobic ammonia oxidation bacteria in the anaerobic ammonia oxidation unit.

An O/A/O biochemical tank (namely, an advanced denitrification unit) is added to a tail end of the anaerobic ammonia oxidation unit for further advanced denitrification, and NH₄⁺—N, NO₂⁻—N ions that are not completely removed in the anaerobic ammonia oxidation process and generated NO₃⁻—N ions are further removed. At the same time, residual COD_{Cr} and BOD₅ are removed by utilizing the metabolism of heterotrophic microorganisms.

The effluent treated in the above stages enters a Fenton unit, and organic compounds such as carboxylic acids, alcohols and esters are oxidized into an inorganic state by using a mixed solution of hydrogen peroxide (H₂O₂) and ferrous ions (Fe²⁺), so that refractory organic pollutants are removed, and intensive mixing of chemicals and the wastewater is ensured by aeration into the water. The effluent enters a post-Fenton reaction tank, flocs are formed by adding a flocculant and sedimented in a Fenton sedimentation tank, the added ferrous ions are removed, and the pH value of the wastewater is adjusted, so that the effluent reaches the standard and is discharged.

The following describes the present disclosure in conjunction with detailed description.

Disclosed is an anaerobic ammonia oxidation treatment system for treating wastewater with high ammonia nitrogen and high COD, specifically a wastewater treatment system in combination with a conventional pretreatment unit, a one-stage A/O biological treatment unit, an anaerobic ammonia oxidation unit, a three-stage A/O biological treatment unit and a Fenton unit. The system is particularly suitable for kitchen wastewater. The system consists of a water collecting tank, an adjustment tank, a pre-denitrification unit, an anaerobic ammonia oxidation unit, an advanced denitrification unit, a Fenton unit, a corresponding sedimentation tank, a water inlet and outlet pipeline, a sludge reflux pipeline and an aeration system.

The present disclosure provides an anaerobic ammonia oxidation treatment system for treating wastewater with high ammonia nitrogen and high COD. The system includes a pre-denitrification unit 15, an anaerobic ammonia oxidation unit 20, an advanced denitrification unit 31 and a Fenton unit 40 which are connected in sequence. The pre-denitrification unit 15 is configured for hydrolyzing suspended pollutants and soluble organic matters in wastewater into organic acids, oxidizing ammonia nitrogen into nitrate, and finally converting the nitrate into nitrogen to be discharged and absorbing phosphorus, so that the purposes of short-cut denitrification and phosphorus removal are achieved. The anaerobic ammonia oxidation unit 20 is configured for converting a part of ammonia nitrogen in the wastewater into nitrite nitrogen through short-cut nitrifying bacteria and reacting the ammonia nitrogen with the nitrite nitrogen through anaerobic ammonia oxidation bacteria to generate nitrogen to be discharged, so that nitrogen source pollutants are removed. The advanced denitrification unit 31 is configured for reducing nitrate nitrogen generated in the anaerobic ammonia oxidation unit 20 into nitrogen to be discharged through a carbon source and removing residual ammonia nitrogen, COD_{Cr} and BOD₅ to realize advanced denitrification. The Fenton unit 40 is configured for removing refractory organic matters and metal ions and adjusting the pH value of effluent, so that the effluent reaches the standard.

Further, the pre-denitrification unit includes a first anoxic tank 16 and a first aerobic tank 12 which are connected. A stirrer 11 is arranged in the first anoxic tank 16. An aeration unit is arranged at the bottom of the first aerobic tank 12. The aeration unit includes an aeration disc 5 connected with a blower 4. The first anoxic tank 16 is configured for hydrolyzing suspended pollutants and soluble organic matters in the wastewater into organic acids through heterotrophic bacteria to short-cutly denitrify the wastewater, converting nitrate brought in by internal backflow into nitrogen to be discharged through denitrifying bacteria. The first aerobic tank 12 is configured for nitrifying the wastewater treated by the first anoxic tank 16 through autotrophic bacteria, so that ammonia nitrogen is oxidized into nitrate; and then the wastewater is refluxed to the first anoxic tank 16, phosphorus is absorbed through phosphorus accumulating bacteria, and residual sludge is discharged to dephosphorize the wastewater.

Further, a first sedimentation tank 14 is also arranged between the pre-denitrification unit 15 and the anaerobic ammonia oxidation unit 20. The first sedimentation tank 14 is configured for refluxing the sludge sedimented at the bottom to the first anoxic tank 16, collecting other residual sludge to a sludge treatment system, and discharging a supernatant to the anaerobic ammonia oxidation unit 20.

Further, the anaerobic ammonia oxidation unit 20 includes a reaction compartment 21 and a second sedimentation tank 24 which are connected. The reaction compartment 21 is divided into a left compartment and a right compartment which are horizontally arranged by a baffle 22. An opening is formed in the baffle. The opening is configured for communicating the left compartment and the right compartment. The left compartment and the right compartment are filled with sponge fillers 23, and aeration units are arranged at the bottoms of the left compartment and the right compartment. The second sedimentation tank 24 is configured for refluxing the sludge sedimented at the bottom to a starting point of the system, collecting residual sludge to a sludge treatment system, and discharging a supernatant to a first adjustment tank 28. The first adjustment tank 28 is configured for homogenizing the supernatant and discharging the homogenized supernatant to the advanced denitrification unit 31.

Further, the number of the openings is two, and the openings are formed in the upper part and the lower part of the baffle 22, respectively.

Further, the advanced denitrification unit 31 includes a second aerobic tank 30, a second anoxic tank 32, a third aerobic tank 33 and a third sedimentation tank 35 which are connected in sequence. A stirrer 11 is arranged in the second anoxic tank. Aeration units are arranged at the bottoms of the second aerobic tank 30 and the third aerobic tank 33. The third sedimentation tank 35 is configured for refluxing the sludge sedimented at the bottom to the second aerobic tank 30, refluxing part of the treated sludge to the pre-denitrification unit 15, discharging the residual sludge into a sludge treatment system, and overflowing a supernatant to the Fenton unit 40.

Further, the Fenton unit 40 includes a Fenton reaction tank 41, a Fenton post-reaction tank 42 and a Fenton sedimentation tank 43 which are connected in sequence, and aeration units are arranged at the bottoms of the Fenton reaction tank 41 and the Fenton post-reaction tank 42. The Fenton reaction tank 41 is configured for the refractory organic matters that are not removed in the anaerobic ammonia oxidation unit 20 and generated bubble mixed water and discharging the effluent to the post-Fenton reaction tank 42. The post-Fenton reaction tank 42 is configured for removing metal ions and adjusting the pH value of the effluent after the water is homogenized, and discharging the effluent to the Fenton sedimentation tank 43. The Fenton sedimentation tank 43 is configured for treating the sludge 44 sedimented by the Fenton unit together with the residual sludge generated by other units in a sludge treatment system and discharging the effluent that reaches the standard.

Further, the system also includes a pretreatment unit arranged in front of the pre-denitrification unit 15, and the pretreatment unit is configured for removing suspended solids and animal and vegetable oils in the wastewater and preliminarily decomposing organic matters such as ammonia and nitrogen in the wastewater to realize COD removal.

Further, the pretreatment unit includes a water collecting tank 1 and a second adjustment tank 3. A sewage lift pump 2 is arranged between the water collecting tank 1 and the second adjustment tank 3. The sewage lift pump 2 is configured for sucking the wastewater collected by the water collecting tank 1 to the second adjustment tank 3. An aeration unit is arranged at the bottom of the second adjustment tank 3, and a mud scraper 6 and a waste residue collecting tank 7 are arranged on the top of the second adjustment tank 3. The mud scraper 6 is configured for collecting the suspended solids and oils along a liquid surface and discharging the collected suspended solids and oils to the waste residue collecting tank 7.

The present disclosure provides application of the anaerobic ammonia oxidation treatment system for treating wastewater with high ammonia nitrogen and high COD according to the above mentioned in treating kitchen wastewater.

Firstly, the pre-denitrification unit in the system is not set in a conventional anaerobic/anoxic/aerobic mode, because the process flow in the conventional mode is large in tank capacity, large in floor space, high in operating cost, large in sludge reflux quantity and high in energy consumption. However, the content of P in kitchen digestive juice is not high, so denitrification is mainly carried out when wastewater is treated. The contribution rate of the anaerobic tank to wastewater treatment effect is not high, so denitrification can be realized in the adjustment tank in the early stage (that is, the second adjustment tank in the system is combined with air flotation equipment and also acts as an anaerobic tank, and ammonia, nitrogen and other organic matters in sewage can be preliminarily decomposed with anaerobic microorganisms to improve the removal rate of COD), and additional investment costs can be saved by omitting the anaerobic tank. However, the anoxic/aerobic process is high in impact load resistance. The system can operate normally when the water quality of the influent is greatly fluctuated or the concentration of the pollutants is high, and the operation and management are simple. In addition, a sedimentation tank (the second sedimentation tank in the system) is added to sediment water entering the anaerobic ammonia oxidation unit, and sediments and other suspended solids that may exist in the adjustment tank and the pre-denitrification unit in the early stage are sedimented, so that the influence on anaerobic ammonia oxidation bacteria in the subsequent system and the normal operation of the equipment is minimized.

Secondly, the anaerobic ammonia oxidation unit in the system is also different from conventional settings. The reaction compartments are separated by the baffle, and openings are formed in the lower part and the upper part of the baffle, respectively, so that up-and-down shuttle flow of water in the reactor is realized. The wastewater flows in one direction, so that intensive mixing circulation of water is realized to the maximum extent, the structure is simple, the cost is saved, and all anaerobic ammonia oxidation bacteria are avoided from being destroyed when an operation accident (a hydraulic impact or a water impact) occurs. The effluent enters the sedimentation tank (the second sedimentation tank in the system) from the upper part, so that enough sedimentation time is provided, and sludge sedimentation is realized.

Finally, the system can be applied to treatment of wastewater, wherein the water quality of the influent is as follows: the concentration of COD_{Cr} is less than or equal to 10000 mg/L/L, the concentration of BOD₅ is less than or equal to 3000 mg/L, the concentration of NH₃—N is less than or equal to 2500 mg/L, the concentration of TN is less than or equal to 3000 mg/L, the concentration of TP is less than or equal to 100 mg/L, the concentration of SS is less than or equal to 4000 mg/L, the concentration of animal and vegetable oils is less than or equal to 200 mg/L, and the pH value is 6 to 8. After treatment by the system, the water quality of the effluent is as follows: the concentration of COD_{Cr} is less than or equal to 500 mg/L, the concentration of BOD₅ is less than or equal to 300 mg/L, the concentration of NH₃—N is less than or equal to 35 mg/L, the concentration of TN is less than or equal to 45 mg/L, the concentration of TP is less than or equal to 5 mg/L, the concentration of SS is less than or equal to 400 mg/L, the concentration of animal and vegetable oils is less than or equal to 100 mg/L, the pH value is 6 to 9, the concentration of NO₂⁻—N is less than or equal to 20 mg/L. It can be seen that after treatment by the system, the removal rates of COD_{Cr}, BOD₅, NH₃—N, TN, TP, SS and animal and vegetable oils reach above 95%, above 90%, above 98%, above 98%, 95%, above 90% and above 50%, respectively.

Specifically, after treatment by the system, the removal efficiency of NH₃—N, TN and COD reaches about 90%, above 92% and about 89%, respectively. After treatment by the anaerobic ammonia oxidation unit, the removal efficiency of NH₃—N, TN and COD reaches 95%, above 95% and about 93%, respectively. In spite of no obvious change of NO₂⁻—N, effective and stable operation of the system still can be ensured.

In conclusion, the system can treat organic matters with high COD while wastewater with high ammonia nitrogen is treated, so that the addition of external carbon sources can be reduced. Moreover, anaerobic ammonia oxidation bacteria have certain tolerance to high organic carbon sources. There is no accumulation of NO₂⁻—N, so that the engineering application of high organic wastewater treatment is realized. Ammonia nitrogen produced by the anaerobic ammonia oxidation unit is reduced by using rear O/A/O (Oxic/Anoxic/Oxic) devices, the total nitrogen removal rate (above 98%) is further improved, and residual COD_{Cr} and BOD₅ are removed. The fillers include XQ-II enhanced carriers containing enzymes and biological activators, so that the organisms are highly concentrated (10000 mg/L to 15000 mg/L) to keep the activity. At the same time, efficient degradation of organic pollutants in the water is realized, the biochemical treatment time is shortened, and the treatment effect is improved, so that the water quality of the effluent quality reaches the standard stably.

More specifically, in the anaerobic ammonia oxidation unit, special fillers, aeration units, instrument control systems, reserved alkalinity and nutrient feeding systems and water distribution tanks for anaerobic ammonia oxidation are matched.

Incoming water from the pretreatment unit is preliminarily diluted in the water distribution tank to reduce the impact of high ammonia nitrogen concentration on the system and ensure the stable operation of the system.

The adjustment tank in front of the pre-denitrification unit is mainly configured for adjustment water quality and water quantity, and has the function of anaerobic fermentation. Anaerobic biological treatment is carried out on sewage with the anaerobic microorganisms, and the organic matters such as ammonia and nitrogen in sewage are preliminarily decomposed, so that the removal rate of COD is improved.

The Fenton unit mainly includes a Fenton reaction zone and a coagulation sedimentation zone. Hydrogen peroxide, ferrous sulfate and pH regulator sulfuric acid are added to Fenton reaction tank to prevent ferrous ions from being oxidized. With a strong oxidation effect of hydroxyl radicals formed by the reaction of hydrogen peroxide and ferrous ions, the refractory organic matters that are not removed by the anaerobic ammonia oxidation system are removed. In the post-Fenton reaction tank, PAM and alkali liquor are configured for promoting flocculation to form sedimentation and remove added ferrous ions.

### Embodiment I

After the wastewater is collected by the water collecting tank 1, the wastewater is sucked into the second adjustment tank 3 by the sewage lift pump 2 to adjust the water quantity and water quality. The wastewater is subjected to anaerobic biological treatment by using anaerobic microorganisms, and the organic matters such as ammonia and nitrogen in the wastewater are preliminarily decomposed to improve the removal rate of COD. At the same time, the blower 4 and the aeration disc 5 are equipped for aeration. By adding polyaluminum chloride (PAC) and polyacrylic amide (PAM), oils and water are separated from the wastewater while suspended solids, most of phosphate and part of COD in the wastewater are removed. Most of oils are removed. The suspended solids and oils in the wastewater are fully mixed with “microbubbles”. The oils and suspended solids are brought to the water surface in the rising process. The mud scraper 6 moves along the liquid surface to collect the suspended solids and oil, and temporarily discharges the suspended solids and oils to the waste residue collecting tank 7, and then transports the suspended solids and oils in the waste residue collecting tank 7 to the sludge treatment system through the residual sludge pipeline 8 for sludge treatment. After the wastewater passes through the aeration disc (the aeration unit includes the aeration tray 5 and the matched blower 4), all or most of the refractory substances can be removed, and the preliminarily purified wastewater is lifted by a second adjustment tank sewage lift pump 9 and enters the pre-denitrification unit 15 for pre-denitrification treatment through a water inlet pipeline 10 of the pre-denitrification unit.

The pre-denitrification unit 15 includes a first anoxic tank 16 and a first aerobic tank 12 which are connected. A stirrer 11 is arranged in the first anoxic tank 16. An aeration disc 5 is arranged in the first aerobic tank 12. The first aerobic tank 12 is aerated by the blower 4. The wastewater firstly enters the first anoxic tank 16, and the concentration of dissolved oxygen is ensured to be less than 0.3 mg/L under the action of the stirrer 11 in the tank. In the first anoxic tank 16, the suspended pollutants such as starch, fiber and carbohydrate and soluble organic substances in the wastewater are hydrolyzed into organic acids by heterotrophic bacteria, so that macromolecular organic substances are decomposed into micromolecule organic substances, and insoluble organic substances are converted into soluble organic substances, so that the biodegradability is improved. At the same time, nitrate brought in by internal reflux is converted into nitrogen to be escaped into the atmosphere through biological denitrification by denitrifying bacteria. The wastewater treated by the first anoxic tank 16 enters the first aerobic tank 12 at the back end. Under the sufficient oxygen supply condition of heterotrophic bacteria, NH₃—N(NH₄⁺) ions are oxidized into NO₃⁻ ions by nitrification of autotrophic bacteria, and the NO₃⁻ ions are returned to the first anoxic tank 16 through reflux control, so that the inhibition of the generated NO₃⁻ ions on the subsequent anaerobic ammonia oxidation bacteria is reduced. At the same time, the phosphorus removal purpose is realized through the discharge of residual sludge by utilizing the characteristics that phosphorus is excessively absorbed by phosphorus accumulating bacteria. In addition, the microorganisms in the aerobic tank use oxygen for biological metabolism, the organic matters are degraded, and the inhibitory or toxic effect of excessive COD on the anaerobic ammonium oxidation bacteria is reduced.

The pre-denitrogenation unit 15 is connected with the first sedimentation tank 14 through a water outlet pipeline 13 of the pre-denitrification unit. The first sedimentation tank 14 is a radial sedimentation tank, and the generated sludge is sedimented at the bottom and then refluxed to the first anoxic tank 16 through a sludge reflux pipeline 17 of the pre-denitrogenation unit by a sludge reflux pump 18 of the pre-denitrogenation unit, so that the microbial activity of the anoxic tank and the aerobic tank is ensured, and other residual sludge is collected to the sludge treatment system (this part is not involved in the present disclosure, the same below) through a residual sludge pipeline 25 for further treatment. The supernatant at the upper part of the first sedimentation tank 14 is connected with the integrated anaerobic ammonia oxidation unit 20 through a water outlet pipeline 19 of the pre-denitrification unit.

The anaerobic ammonia oxidation unit 20 is a continuous flow shuttle reactor consisting of a reaction compartment 21 and a second sedimentation tank 24. The aeration disc 5 is arranged at the bottom of the reaction compartment 21. The reaction compartment 21 is aerated by the blower 4. The reaction compartment 21 is filled with sponge fillers 23 loaded with integrated anaerobic ammonium oxidation sludge, and is fixed by a frame to avoid suspension. The filling rate is controlled at 25% to 30%. The anaerobic ammonium oxidation sludge mainly includes short-cut nitrifying bacteria and anaerobic ammonium oxidation bacteria. The short-cut nitrifying bacteria convert a part of ammonia nitrogen in the wastewater into nitrite nitrogen with O₂ provided by aeration, and the anaerobic ammonium oxidation bacteria use ammonia nitrogen and nitrite nitrogen as reaction substrates to generate nitrogen to be discharged from the upper part of the reactor, so that efficient removal of nitrogen source pollutants is realized, and about 10% of nitrate nitrogen is produced at the same time. The reaction compartments 21 are separated by the baffle 22, and openings are formed in the lower part and the upper part of the baffle 22, respectively, so that up-and-down shuttle flow of water in the reactor is realized. The wastewater flows in one direction, so that intensive mixing circulation of water is realized to the maximum extent, the structure is simple, the cost is saved, and all anaerobic ammonia oxidation bacteria are avoided from being destroyed when an operation accident such as a hydraulic impact or a water impact occurs. The effluent enters the second sedimentation tank 24 from the upper part, so that enough sedimentation time is provided, and sludge sedimentation is realized. The second sedimentation tank 24 is a radial sedimentation tank with simple operation and management and good sludge sedimentation effect. The bottom sludge is refluxed to an inlet of the device by a sludge reflux pump 49 of the anaerobic ammonia oxidation unit through a sludge reflux pipeline 26 of the anaerobic ammonia oxidation unit. The reflux ratio is 100% to 150%. The residual sludge is transported to the sludge treatment system through a residual sludge pipeline 48 of the anaerobic ammonia oxidation unit for treatment. The supernatant overflows into the first adjustment tank 28 through a water outlet pipe 27 of the anaerobic ammonia oxidation unit for homogenization, and the homogenized effluent enters the advanced denitrification unit 31 through a water outlet pipeline 29 of the first adjustment tank.

The advanced denitrification unit 31 consists of a second aerobic tank 30, a second anoxic tank 32 and a third aerobic tank 33 for advanced denitrification to ensure the stability of the process and the reliability that the water reaches the standard. The stirrer 11 is arranged in the second anoxic tank 32, and the dissolved oxygen in the reactor is controlled to be in an anoxic state of less than 0.3 mg/L by stirring. The aerobic tank is aerated by the blower 4 through the aeration disc 5, and the dissolved oxygen in the system is controlled at 2 mg/L to 4 mg/L. The sludge in the reactor is mainly applied to autotrophic denitrifying bacteria. Under an anoxic condition, HCO3-, CO32- and other inorganic carbon are used as carbon sources to reduce the nitrate nitrogen produced by anaerobic ammonia oxidation into nitrogen to be discharged, so that higher nitrogen removal rate is achieved. The effluent at the upper part enters the third sedimentation tank 35 through a water outlet pipeline 34. Muddy water separation is carried out in the third sedimentation tank 35. The sludge at the bottom is refluxed to the second aerobic tank 30 through a sludge reflux pump 36 of the advanced denitrification unit and a sludge reflux pipeline 37 of the advanced denitrification unit. The reflux ratio is 100% to 150%. The residual sludge enters the sludge treatment system through a residual sludge pipeline 47 of the advanced denitrification unit for further treatment. A biological system sludge reflux pipeline 38 is arranged at the upper part of the third sedimentation tank 35. The short-cutly treated sludge is refluxed to the pre-denitrification unit 15 through the biological system sludge reflux pipeline 38 by a biological system sludge reflux pump 46. The reflux ratio is 300% to 500%, so that the water quality of the biochemical stage reactor is more balanced and free ammonia is prevented from being generated by excessively high ammonia nitrogen. The supernatant overflows to a water outlet pipeline 39 of the advanced denitrification unit and enters the Fenton unit 40 for final treatment.

The Fenton unit 40 mainly consists of a Fenton reaction tank 41, a Fenton post-reaction tank 42 and a subsequent Fenton sedimentation tank 43. The effluent from the system enters the Fenton reaction tank 41, and hydrogen peroxide, ferrous sulfate and pH regulator sulfuric acid are added into the Fenton reaction tank to prevent ferrous ions from being oxidized. With a strong oxidation effect of hydroxyl radicals formed by the reaction of hydrogen peroxide and ferrous ions, the refractory organic matters that are not removed by the anaerobic ammonia oxidation system are removed, and air is transported to the aeration disc 5 at the bottom of the tank by the blower 4, so that the purpose of mixing water is achieved through the generated bubbles. The effluent enters the post-Fenton reaction tank 42, and the air is transported to the aeration disc 5 at the bottom of the tank by the blower 4, so that the chemicals and the wastewater are mixed, and the water quality is homogenized. An alkaline solution and a PAM coagulant aid are added to the post-Fenton reaction tank 42 to help forming ferrous ion sedimentation, so that metal ions are removed, and the pH value of the effluent is adjusted. The effluent is further separated from the sludge in the subsequent Fenton sedimentation tank 43, and Fenton unit sedimentation sludge 44 is treated together with the residual sludge generated by other units in the sludge treatment system. The effluent from Fenton sedimentation tank reaches the standard to be discharged through a water outlet pipe 45 of the Fenton unit.

### Application Example I

The kitchen waste wastewater in the first application example is treated by the anaerobic ammonia oxidation treatment system for treating wastewater with high ammonia nitrogen and high COD provided by the present disclosure. The water inflow is 188 m³/d, the concentration of NH₃—N in the inflow is 2612 mg/L, the concentration of NH₃—N in the effluent is 5 mg/L, and the removal rate of NH₃—N reaches 98.7%. The concentration of COD_{Cr} in the inflow is 10230 mg/L, the concentration of COD_{Cr} in the effluent is 310 mg/L, and the removal rate of COD_{Cr} reaches 96.9%. The concentration of TN in the inflow is 2702 mg/L, the concentration of TN in the effluent is 27 mg/L, and the removal rate of TN reaches 99%. It can be seen that the treatment system provided by the present disclosure can save carbon sources and sludge treatment cost.

### Application Example II

The kitchen waste wastewater in the second application example is treated by the anaerobic ammonia oxidation treatment system for treating wastewater with high ammonia nitrogen and high COD provided by the present disclosure. The water inflow is 169 m³/d, the concentration of NH₃—N in the inflow is 2149 mg/L, the concentration of NH₃—N in the effluent is 6 mg/L, and the removal rate of NH₃—N reaches 99.7%. The concentration of COD_{Cr} in the inflow is 11740 mg/L, the concentration of COD_{Cr} in the effluent is 545 mg/L, and the removal rate of COD_{Cr} reaches 95.3%. The concentration of TN in the inflow is 2226 mg/L, the concentration of TN in the effluent is 20 mg/L, and the removal rate of TN reaches 99.1%.

It can be understood by those skilled in the art that the above-mentioned embodiments are specific embodiments for realizing this application, but in practical application, various changes can be made in form and details without departing from the spirit and scope of this application. Those skilled in the art can make changes and modifications without departing from the spirit and scope of this application, so the scope of protection of this application should be based on the scope defined by the claims.

What is claimed is:

1. An anaerobic ammonia oxidation treatment system for treating wastewater with high ammonia nitrogen and high COD (Chemical Oxygen Demand), comprising a pre-denitrification unit (15), an anaerobic ammonia oxidation unit (20), an advanced denitrification unit (31) and a Fenton unit (40) which are connected in sequence, wherein
the pre-denitrification unit (15) is configured for hydrolyzing suspended pollutants and soluble organic matters in wastewater into organic acids, oxidizing ammonia nitrogen into nitrate, and finally converting the nitrate into nitrogen to be discharged and absorbing phosphorus, so as to achieve short-cut denitrification and phosphorus removal;
the anaerobic ammonia oxidation unit (20) is configured for converting a part of ammonia nitrogen in the wastewater into nitrite nitrogen through short-cut nitrifying bacteria and reacting the ammonia nitrogen with the nitrite nitrogen through anaerobic ammonia oxidation bacteria to generate nitrogen to be discharged, so as to remove nitrogen source pollutants;
the advanced denitrification unit (31) is configured for reducing nitrate nitrogen generated in the anaerobic ammonia oxidation unit (20) through a carbon source into nitrogen to be discharged and removing residual ammonia nitrogen, COD_{Cr} and BOD₅ (Biochemical Oxygen Demand), so as to achieve an advanced denitrification; and
the Fenton unit (40) is configured for removing refractory organic matters and metal ions and adjusting the pH value of discharged water, so that the discharged water reaches standard.

2. The anaerobic ammonia oxidation treatment system for treating wastewater with high ammonia nitrogen and high COD according to claim 1, wherein the pre-denitrification unit comprises a first anoxic tank (16) and a first aerobic tank (12) which are connected to each other, a stirrer (11) is arranged in the first anoxic tank (16), a first aeration unit is arranged at a bottom of the first aerobic tank (12) and comprises an aeration disc (5) connected with a blower (4);
the first anoxic tank (16) is configured for hydrolyzing suspended pollutants and soluble organic matters in the wastewater into organic acids through heterotrophic bacteria to short-cutly denitrify the wastewater, converting nitrate brought in by internal backflow into nitrogen to be discharged through denitrifying bacteria;
the first aerobic tank (12) is configured for nitrifying the wastewater treated by the first anoxic tank (16) through autotrophic bacteria to oxidize ammonia nitrogen into nitrate; and then the wastewater is refluxed to the first anoxic tank (16), phosphorus is absorbed through phosphorus accumulating bacteria and residual sludge is discharged to dephosphorize the wastewater.

3. The anaerobic ammonia oxidation treatment system for treating wastewater with high ammonia nitrogen and high COD according to claim 2, wherein a first sedimentation tank (14) is also arranged between the pre-denitrification unit (15) and the anaerobic ammonia oxidation unit (20); and
the first sedimentation tank (14) is configured for refluxing sludge sedimented at a bottom thereof to the first anoxic tank (16), collecting residual sludge in the first sedimentation tank (14) to a sludge treatment system, and discharging a supernatant in the first sedimentation tank (14) to the anaerobic ammonia oxidation unit (20).

4. The anaerobic ammonia oxidation treatment system for treating wastewater with high ammonia nitrogen and high COD according to claim 1, wherein the anaerobic ammonia oxidation unit (20) comprises a reaction compartment (21) and a second sedimentation tank (24) which are connected to each other, the reaction compartment (21) is divided by a baffle (22) into a left compartment and a right compartment which are horizontally arranged, an opening is formed in the baffle, and the opening is configured for communicating the left compartment with the right compartment;
the left compartment and the right compartment are filled with sponge fillers (23), and second aeration units are arranged at bottoms of the left compartment and the right compartment;
the second sedimentation tank (24) is configured for refluxing sludge sedimented at a bottom thereof to the reaction compartment (21), collecting residual sludge in the second sedimentation tank (24) to a sludge treatment system, and discharging a supernatant in the second sedimentation tank (24) to a first adjustment tank (28); and
the first adjustment tank (28) is configured for homogenizing the supernatant in the second sedimentation tank (24) and discharging the homogenized supernatant to the advanced denitrification unit (31).

5. The anaerobic ammonia oxidation treatment system for treating wastewater with high ammonia nitrogen and high COD according to claim 4, wherein a number of the openings is two, and one of the openings is formed in an upper part of the baffle (22), the other of the openings is formed in a lower part of the baffle (22).

6. The anaerobic ammonia oxidation treatment system for treating wastewater with high ammonia nitrogen and high COD according to claim 1, wherein the advanced denitrification unit (31) comprises a second aerobic tank (30), a second anoxic tank (32), a third aerobic tank (33) and a third sedimentation tank (35) which are connected in sequence, a stirrer (11) is arranged in the second anoxic tank, and third aeration units are arranged at bottoms of the second aerobic tank (30) and the third aerobic tank (33); and
the third sedimentation tank (35) is configured for refluxing sludge sedimented at a bottom thereof to the second aerobic tank (30), refluxing part of the treated sludge to the pre-denitrification unit (15), discharging the residual sludge in the third sedimentation tank (35) into a sludge treatment system, and overflowing a supernatant in the third sedimentation tank (35) to the Fenton unit (40).

7. The anaerobic ammonia oxidation treatment system for treating wastewater with high ammonia nitrogen and high COD according to claim 1, wherein the Fenton unit (40) comprises a Fenton reaction tank (41), a Fenton post-reaction tank (42) and a Fenton sedimentation tank (43) which are connected in sequence, and fourth aeration units are arranged at bottoms of the Fenton reaction tank (41) and the Fenton post-reaction tank (42);
the Fenton reaction tank (41) is configured for refractory organic matters that are not removed in the anaerobic ammonia oxidation unit (20) and water mixed with generated bubble, and discharging a first discharged water to the post-Fenton reaction tank (42);
the post-Fenton reaction tank (42) is configured for removing metal ions from and adjusting the pH value of the first discharged water after the first discharged water is homogenized, and discharging a second discharged water to the Fenton sedimentation tank (43); and
the Fenton sedimentation tank (43) is configured for treating Fenton unit sedimentation sludge (44) together with residual sludge generated by other units in a sludge treatment system, and discharging a third discharged water that reaches standard.

8. The anaerobic ammonia oxidation treatment system for treating wastewater with high ammonia nitrogen and high COD according to claim 1, further comprising a pretreatment unit arranged in front of the pre-denitrification unit (15), and the pretreatment unit is configured for removing suspended solids and animal and vegetable oils in the wastewater and preliminarily decomposing organic matters such as ammonia and nitrogen in the wastewater to realize COD removal.

9. The anaerobic ammonia oxidation treatment system for treating wastewater with high ammonia nitrogen and high COD according to claim 8, wherein the pretreatment unit comprises a water collecting tank (1) and a second adjustment tank (3), a sewage lift pump (2) is arranged between the water collecting tank (1) and the second adjustment tank (3), and the sewage lift pump (2) is configured for pumping wastewater collected by the water collecting tank (1) to the second adjustment tank (3); and
an fifth aeration unit is arranged at a bottom of the second adjustment tank (3), a mud scraper (6) and a waste residue collecting tank (7) are arranged on a top of the second adjustment tank (3), the mud scraper (6) is configured for moving along a liquid surface to collect the suspended solids and oils and discharging the collected suspended solids and oils to the waste residue collecting tank (7).

10. A kitchen wastewater treatment system, comprising an anaerobic ammonia oxidation treatment system for treating wastewater with high ammonia nitrogen and high COD according to claim 1.

11. The kitchen wastewater treatment system according to claim 10, wherein the pre-denitrification unit comprises a first anoxic tank (16) and a first aerobic tank (12) which are connected to each other, a stirrer (11) is arranged in the first anoxic tank (16), a first aeration unit is arranged at a bottom of the first aerobic tank (12) and comprises an aeration disc (5) connected with a blower (4);
the first anoxic tank (16) is configured for hydrolyzing suspended pollutants and soluble organic matters in the wastewater into organic acids through heterotrophic bacteria to short-cutly denitrify the wastewater, converting nitrate brought in by internal backflow into nitrogen to be discharged through denitrifying bacteria;
the first aerobic tank (12) is configured for nitrifying the wastewater treated by the first anoxic tank (16) through autotrophic bacteria to oxidize ammonia nitrogen into nitrate; and then the wastewater is refluxed to the first anoxic tank (16), phosphorus is absorbed through phosphorus accumulating bacteria and residual sludge is discharged to dephosphorize the wastewater.

12. The kitchen wastewater treatment system according to claim 11, wherein a first sedimentation tank (14) is also arranged between the pre-denitrification unit (15) and the anaerobic ammonia oxidation unit (20); and
the first sedimentation tank (14) is configured for refluxing sludge sedimented at a bottom thereof to the first anoxic tank (16), collecting residual sludge in the first sedimentation tank (14) to a sludge treatment system, and discharging a supernatant in the first sedimentation tank (14) to the anaerobic ammonia oxidation unit (20).

13. The kitchen wastewater treatment system according to claim 10, wherein the anaerobic ammonia oxidation unit (20) comprises a reaction compartment (21) and a second sedimentation tank (24) which are connected to each other, the reaction compartment (21) is divided by a baffle (22) into a left compartment and a right compartment which are horizontally arranged, an opening is formed in the baffle, and the opening is configured for communicating the left compartment with the right compartment;
the left compartment and the right compartment are filled with sponge fillers (23), and second aeration units are arranged at bottoms of the left compartment and the right compartment;
the second sedimentation tank (24) is configured for refluxing sludge sedimented at a bottom thereof to the reaction compartment (21), collecting residual sludge in the second sedimentation tank (24) to a sludge treatment system, and discharging a supernatant in the second sedimentation tank (24) to a first adjustment tank (28); and
the first adjustment tank (28) is configured for homogenizing the supernatant in the second sedimentation tank (24) and discharging the homogenized supernatant to the advanced denitrification unit (31).

14. The kitchen wastewater treatment system according to claim 13, wherein a number of the openings is two, and one of the openings is formed in an upper part of the baffle (22), the other of the openings is formed in a lower part of the baffle (22).

15. The kitchen wastewater treatment system according to claim 10, wherein the advanced denitrification unit (31) comprises a second aerobic tank (30), a second anoxic tank (32), a third aerobic tank (33) and a third sedimentation tank (35) which are connected in sequence, a stirrer (11) is arranged in the second anoxic tank, and third aeration units are arranged at bottoms of the second aerobic tank (30) and the third aerobic tank (33); and
the third sedimentation tank (35) is configured for refluxing sludge sedimented at a bottom thereof to the second aerobic tank (30), refluxing part of the treated sludge to the pre-denitrification unit (15), discharging the residual sludge in the third sedimentation tank (35) into a sludge treatment system, and overflowing a supernatant in the third sedimentation tank (35) to the Fenton unit (40).

16. The kitchen wastewater treatment system according to claim 10, wherein the Fenton unit (40) comprises a Fenton reaction tank (41), a Fenton post-reaction tank (42) and a Fenton sedimentation tank (43) which are connected in sequence, and fourth aeration units are arranged at bottoms of the Fenton reaction tank (41) and the Fenton post-reaction tank (42);
the Fenton reaction tank (41) is configured for refractory organic matters that are not removed in the anaerobic ammonia oxidation unit (20) and water mixed with generated bubble, and discharging a first discharged water to the post-Fenton reaction tank (42);
the post-Fenton reaction tank (42) is configured for removing metal ions from and adjusting the pH value of the first discharged water after the first discharged water is homogenized, and discharging a second discharged water to the Fenton sedimentation tank (43); and
the Fenton sedimentation tank (43) is configured for treating Fenton unit sedimentation sludge (44) together with residual sludge generated by other units in a sludge treatment system, and discharging a third discharged water that reaches standard.

17. The kitchen wastewater treatment system according to claim 10, further having a pretreatment unit arranged in front of the pre-denitrification unit (15), and the pretreatment unit is configured for removing suspended solids and animal and vegetable oils in the wastewater and preliminarily decomposing organic matters such as ammonia and nitrogen in the wastewater to realize COD removal.
